(19) United States
(12) Patent Application Publication
(10) Pub. No.: US 2024/0339646 A1
(43) Pub. Date: Oct. 10, 2024

(54) CLAMPING SYSTEM FOR AN ELECTROCHEMICAL MODULE

(71) Applicant: COMMISSARIAT A L'ENERGIE ATOMIQUE ET AUX ENERGIES ALTERNATIVES, Paris (FR)

(72) Inventors: Karl VULLIEZ, Grenoble Cedex 09 (FR); Mathieu MONTEREMAND, Grenoble Cedex 09 (FR); Philippe SZYNAL, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/578,917

(22) PCT Filed: Jul. 6, 2022
(86) PCT No.: PCT/FR2022/051358

§ 371 Date: Jan. 12, 2024

(30) Foreign Application Priority Data
Jul. 15, 2021 (FR) FR21 07667

(51) Int. Cl. H01M 8/248; C25B 9/70; H01M 8/2404

(52) U.S. Cl. CPC H01M 8/248; C25B 9/70; H01M 8/2404

(57) ABSTRACT

A clamping system for an electrochemical module including a stack of electrochemical cells and interconnectors and two stiffening plates at the ends of the stack. The clamping system exerts a compressive force on the stack in the longitudinal direction. Each stiffening plate includes eight holes orthogonal to the stiffening plates and distributed along the edges of the stiffening plates. The clamping system includes eight clamping devices. Each clamping device includes a column configured to mechanically connect to the stiffening plates, and each column extends into the space between the stiffening plates. Each clamping device also includes first and second elements screwed into each of the stiffening plates, fastening the column to the stiffening plates and allowing adjustment of the tension applied to the column.

### TECHNICAL FIELD AND PRIOR ART

The present invention relates to a clamping system for an electrochemical module, intended to apply a compressive force to a stack of cells, in particular during handling thereof.

An electrochemical device may be implemented for high-temperature electrolysis and include a stack of solid-oxide electrolyser cells or SOEC (solid-oxide electrolyser cell in Anglo-saxon terminology) or as fuel cell and include a stack of solid-oxide fuel cells or SOFC (Solid-oxide fuel cell in Anglo-saxon terminology).

Such a device includes a module or stack comprising a stack of electrochemical cells clasped between two clamping plates. The cells are electrically connected in series.

Each electrochemical cell includes an electrolyte between two electrodes. Interconnection plates are interposed between the cells and ensure electrical connection between the cells. Furthermore, the interconnection plates ensure the supply the cells with gas and the collection of the gases produced at each cell. The document EP3183379 describes an example of an interconnection plate or connector ensuring the electrical connection and the distribution of the gases within the cells. The interconnector includes three plates with a small thickness, one of the plates referred to as the intermediate plate arranged between the other two plates, called end plates, enables the distribution of the gases within the O₂ and H₂ chambers.

One of the end plates forms a frame delimiting an aperture on the intermediate plate and receiving a cell which is then in contact with the intermediate plate. The electrical current flows from the bottom to the top or from the top to the bottom through the cells and the areas of the interconnectors, which are vertically aligned with the cells.

In operation, the anode and the cathode are the site of electrochemical reactions, whereas the electrolyte enables the transport of ions from the cathode to the anode, or vice versa, depending on whether the electrochemical device is operating in an electrolyser mode or in a fuel cell mode.

Thus, in the electrolyser mode, the cathode compartment enables a supply of water vapour and a discharge of the water reduction products, in particular hydrogen, whereas the anode compartment ensures, via a draining gas, the discharge of the dioxygen produced from the oxidation of the O²⁻ ions migrating from the cathode to the anode.

The electrolysis mechanism (“SOEC” mode) of the water vapour by an elementary electrochemical cell is described hereinbelow. During this electrolysis, the elementary electrochemical cell is supplied by a current flowing from the cathode to the anode. The water vapour delivered by the cathode compartment is then reduced under the effect of the current according to the following half-reaction:

$$2 {H}_{2} O + 4 {e}^{-} \to 2 {H}_{2} + 2 {O}^{2 -} .$$

The dihydrogen produced during this reaction is then evacuated, whereas the O²⁻ ions produced during this reduction migrate from the cathode to the anode, via the electrolyte, where they are oxidised into dioxygen according to the half-reaction:

$$2 {O}^{2 -} \to {O}_{2} + 4 {e}^{-} .$$

In turn, the dioxygen thus formed is discharged by the draining gas circulating in the anode compartment.

The electrolysis of the water vapour corresponds to the following reaction:

$$2 {H}_{2} O \to 2 {H}_{2} + {O}_{2} .$$

In the fuel cell mode (“SOFC”), air is injected into the cathode compartment which is dissociates into O²⁻ ions. These migrate towards the anode and react with dihydrogen circulating in the anode compartment to form water. Alternatively, the fuel cell is supplied with CH₄ and air.

Operation in the fuel cell mode enables the production of an electrical current.

These systems can operate at temperatures comprised between 600° C. and 1,000° C.

The clamping plates exert a clamping force on the stack in order to ensure good electrical contact between the interconnection plates and the cells and sealing of the stack. Tie rods connect the clamping plates.

The development of industrial systems integrating high-temperature electrolysers involves an increase in the volume of treated gas (in SOEC or SOFC). To do so, the increase in the surface area and in the number of the cells and in the number of interconnector plates is necessary. A significant increase in the number of plates and in the height of the stacks poses many technical difficulties. In order to overcome these difficulties and to make stacks with larger dimensions, it has been considered to make assemblies including several modules consisting of a reduced number of cells and interconnection plates.

For example, to make an assembly of 75 cells, three modules of 25 cells each are made and then superposed. Each module is made separately. Yet, the application of a compressive force should be held on the cells and interconnectors throughout all of the manufacturing phases.

A seal made of glass-ceramic over the lateral contour of the cells is made for each module. Sealing is done under a temperature in the range of 800° C. During this sealing, a compressive force is applied. During the handling phases, this force should be held.

Afterwards, when the modules are superposed to make the final assembly, a new sealing is made by applying a high temperature.

At the end of this sealing, the compressive force on the final assembly is held by means of clamping plates located at the ends of the assembly and connected by tie rods.

During the sealing phases, holding under pressure is done by means of a press rather than tie rods, since these would be welded at the threads by application of the high temperature. Furthermore, the implementation of tie rods on the stacks would have a large size.

### Disclosure of the Invention

Consequently, the present invention aims to provide means for ensuring holding of the application of a compressive force to a stack of electrochemical cells and interconnection plates, devoid of the drawbacks hereinabove, and in particular not hindering the superposition of the modules or the placement of the final compression system.

The aim stated hereinabove is achieved by a clamping system including a set of clamping devices, each clamping device including a column extending between the stiffening plates and being fastened thereto so that the external faces of the stiffening plates remain planar and allow making stiffening plates and electrochemical modules that are easily stackable. Furthermore, the columns remain in the space delimited between the plates, which makes the device compact.

In other words, the invention provides means for temporarily clamping a stack of cells and interconnectors which do not increase the size of the stack.

Quite advantageously, the clamping devices are such that they allow implementing two identical stiffening plates.

Preferably, the stiffening plates are square or rectangular and one to three clamping devices per side are provided.

In one embodiment, the columns are rigid.

In another embodiment, the columns are formed by cables fastened to each other.

An object of the present application is then a clamping system for a module including a stack of electrochemical cells and interconnectors in a longitudinal direction, and a first stiffening plate and a second stiffening plate on either side of the stack, said clamping system being intended to exert a compressive force on said stack in the longitudinal direction, each first and second stiffening plates including n holes orthogonal to the stiffening plates and distributed along the edges of the stiffening plates, n being an integer at least equal to 2, said clamping system including n clamping devices, each clamping device including a column configured to mechanically connect the first and second stiffening plates, each column extending in the space between the first and second stiffening plates, each clamping device also including first means penetrating each of the first and second stiffening plates and fastening the column to said first and second stiffening plates and second adjustment means for adjusting the tension applied to the column.

In one embodiment, the first means include, at each of the stiffening plates, a room for a column head, configured to enable mounting of a column head in the room by lateral movement of the column.

In particular, the first means may include at least one first tapped element configured to be screwed into a hole of one of the stiffening plates.

The column may include, at a first longitudinal end, a head cooperating with the first tapped element and, at a second longitudinal end, a head intended to be connected to the second stiffening plate, and wherein the second adjustment means are formed by cooperation of the first tapped element with the first stiffening plate.

The first tapped element may include a room for a column head, configured to enable mounting of a column head in the room by lateral movement of the column.

In addition, the first means may include a second tapped element configured to be screwed into a kit of the second stiffening plate, and the second tapped element may include a room for a column head, configured to enable mounting of a column head in the room by lateral movement of the column.

Advantageously, the rooms and the heads are configured to form a lateral clearance therebetween.

The clamping device may include at least one nut configured to be mounted with a lateral clearance in a hole of the second stiffening plate and to be immobilised in translation in the axial direction at least in a direction opposite to that in which the second tapped element is screwed into the hole.

In another embodiment, each column includes two cables, each configured to be fastened by a first end at least in translation in the axial direction to the first and second stiffening plates and including at a second end means for connecting the cables together, forming the adjustment means. The first means may include a second tapped element configured to be screwed into a hole of the second stiffening plate, the first end of a cable being welded in the first tapped element and the first end of the other cable being welded in the second tapped element.

For example, the adjustment means include a nut mounted free to rotate on the second end of one of the cables and a tapped pin mounted on the second end of the other cable.

According to an additional feature, at least one clamping device includes a strain gauge configured to supply the tension applied to the column.

Another object of the present application is a module including a stack of electrochemical cells and interconnectors and a first and second stiffening plates on either side of the stack and a clamping system according to the invention, the first and second stiffening plates including holes for mounting the clamping devices arranged along the edges of the stiffening plates.

The holes of the second stiffening plate may open laterally into the edges of the second stiffening plate, said holes including a shoulder forming a bearing face for a column head.

For example, the nut includes a collar bearing against an area of the external face of the second stiffening plate, and said area includes a counterbore so that the collar does not project from a main plane of said external face.

Another object of the present application is a method for compressing a stack of electrochemical cells and interconnectors by means of a clamping system according to the invention, including:
a) providing a stack of electrochemical cells and interconnectors and first and second stiffening plates on either side of the stack, each of said plates including n holes orthogonal to the first and second stiffening plates and distributed along the edges of the stiffening plates,
b) mounting a first tapped element in a hole of the first stiffening plate for each mounting device,
c) mounting the column between said first element and the second plate,
d) tensioning said column.

During step d), tensioning may be achieved by screwing the first tapped element into the hole.

During step c), a second tapped element may be mounted in a hole of the second stiffening plate and wherein during step d), tensioning is achieved by screwing the first element into the hole and/or screwing the second element into the hole.

Another object of the present application is a method for compressing a stack of electrochemical cells and interconnectors by means of a clamping system according to the invention, including:
a) providing a stack of electrochemical cells and interconnectors and first and second stiffening plates on either side of the stack, each of said plates including n holes orthogonal to the first and second stiffening plates and distributed along the edges of the first and second stiffening plates,
b) mounting a first tapped element in a hole of a first stiffening plate for each mounting device,
c) mounting a second tapped element in a hole of the second stiffening plate for each mounting device,
d) connecting said cables and tensioning said cables.

Another object of the present application is a method for manufacturing an electrochemical assembly forming an electrolysis or co-electrolysis reactor SOEC or a fuel cell SOFC, including a superposition of p modules, p being an integer at least equal to 2, comprising:
a′) Providing a stack of electrochemical cells and interconnectors and first and second stiffening plates on either side of the stack, each of said plates including n holes orthogonal to the first and second stiffening plates and distributed along the edges of the stiffening plates,
b′) Placing said stack and first and second stiffening plates in a press,
c′) Applying a given axial compressive force,
d′) Making a seal between the cells and the interconnectors
e′) Placing the clamping system by applying the method according to the invention,
f′) repeating steps a′) to e′) to manufacture p modules,
g′) superposing the modules
h′) placing said superposed modules in a press
i′) applying an axial compressive force to the superposed modules,
j′) removing clamping systems from all of the modules,
k′) making a seal between the modules,
l′) mounting a system for holding said modules in compression,
m′) removing the press.

### BRIEF DESCRIPTION OF THE DRAWINGS

The present invention will be better understood based on the following description and the appended drawings wherein:

FIG. 1 is a schematic illustration of a perspective view of an example of an electrochemical assembly according to the invention.

FIG. 2 is a perspective view of an electrochemical module implementing a clamping system according to an embodiment according to the invention.

FIG. 3 is a perspective view of a tapped element of a clamping device implemented in the module of FIG. 2.

FIG. 4 is a side view of the tapped element of FIG. 3.

FIG. 5A is a detail view of a clamping device of FIG. 2 during the mounting phase.

FIG. 5B shows the clamping device of FIG. 2 during the tension adjustment phase.

FIG. 6 is a perspective view of a detail of a module according to a variant of the clamping system of FIG. 2.

FIG. 7A is a sectional view at a nut mounted in the second stiffening plate in a first position.

FIG. 7B is a sectional view at the nut mounted in the second stiffening plate in a second position.

FIG. 8 is a perspective view of an electrochemical module implementing a clamping system according to another embodiment according to the invention.

FIG. 9 is a detail view of FIG. 8 according to a first viewpoint.

FIG. 10 is a detail view of FIG. 8 according to a first viewpoint.

FIG. 11 is a perspective view of a portion of an electrochemical module implementing a clamping system according to another embodiment according to the invention.

FIG. 12A is a detail view of a clamping device of FIG. 11.

FIG. 12B is a longitudinal sectional view of the clamping device of FIG. 12A.

### DETAILED DISCLOSURE OF PARTICULAR EMBODIMENTS

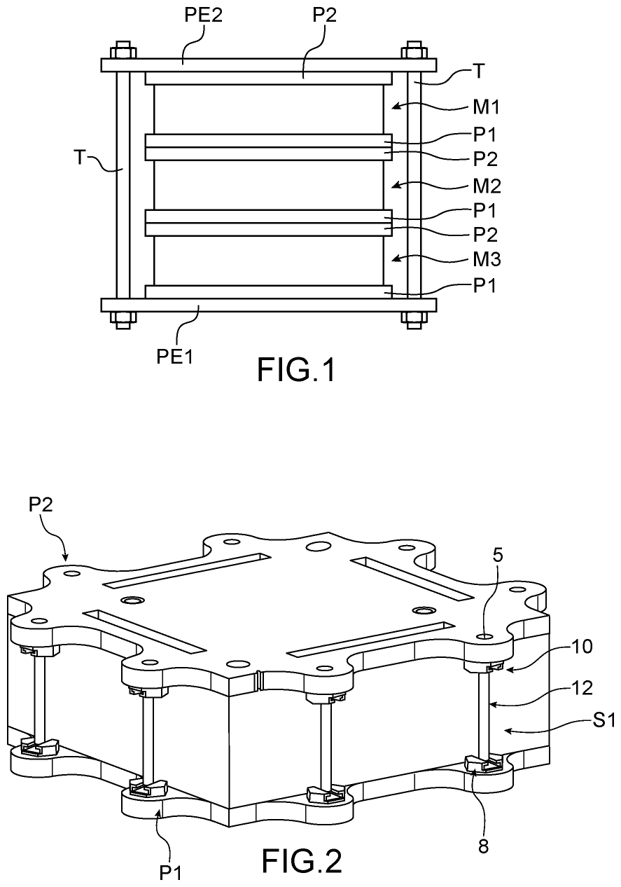

FIG. 1 shows a side view of an example of assembly of electrochemical cells and of electrical and fluidic interconnectors, wherein the cells and the interconnectors are distributed in several modules M1, M2, M3, three in the illustrated example. Each module includes a stack of electrochemical cells and interconnectors, each cell being arranged between two interconnectors. Each electrochemical cell includes an electrolyte between two electrodes. Two stiffening plates P1, P2 are provided at the ends of the stack and enable the application of a compressive force to the stack of cells and interconnectors. The stiffening plates P1, P2 also ensure electrical connection with the stacks located above and below and the fluidic connection.

The electrochemical assembly includes two end plates PE1, PE2 forming electrical and fluidic connectors for conveying or collecting the electrical current from the electrochemical assembly to the outside and for conveying, collecting and circulating the gases from the electrochemical assembly to the outside. Furthermore, tie rods T connect the two end plates PE1, PE2 and ensure application of a compressive force to all of the modules during the operation of the device.

In FIG. 2, one could see a module M1 alone including a clamping system S1 according to one embodiment. The clamping system is intended to ensure temporary application of a compressive force to the stack of cells and interconnectors, in particular during the phases of handling the module and carrying out the final assembly. The clamping system S1 is not intended to be used during the manufacturing phases requiring high temperatures, for example when making glass or glass-ceramic joints between the cells and the interconnectors. During these phases, holding of the compression force is achieved by means of a press.

The clamping system S1 is configured to cooperate with the stiffening plates P1 and P2.

In this example, the two plates P1, P2 are identical or similar, only the plate P1 will be described in detail.

The first plate P1 includes an inner face 2 intended to be in contact with the stack of cells and interconnectors. The first plate P1 includes threaded holes (not visible) extending according to a direction of the thickness of the plate P1. In this example, the holes cross the plate P1. The holes are distributed over the entire contour of the plate P1. In the illustrated example, the plate P1 has a substantially square shape and it includes lugs 6 extending laterally outwards, a threaded hole is formed in each of them.

The plate P2 includes the same number of threaded holes 5 as the plate P1, which have the same arrangement so that, when the plates P1 and P2 are arranged on either side of the stack, each threaded hole of a plate substantially faces a threaded hole of the other plate when considering a vertical direction.

The number of holes per side is not restrictive and is selected according to the dimensions of the stiffening plates.

The implementation of lugs allows reducing the mass of the stiffening plates.

The clamping system includes a set of several clamping devices intended to be distributed around the stack in order to ensure application of a balanced compressive force.

Each clamping device includes a first element 8 configured to cooperate by screwing with a threaded hole of the plate P1, a second element 10 configured to cooperate by screwing with a threaded hole 5 of the plate P2 and a column 12 configured to mechanically connect the first element 8 and the second element 10 in a rigid manner and ensure application of a tensile force between the first and second elements.

In this example, the first element 8 and the second element 10 are identical or similar, only the first element 8 will be described in detail.

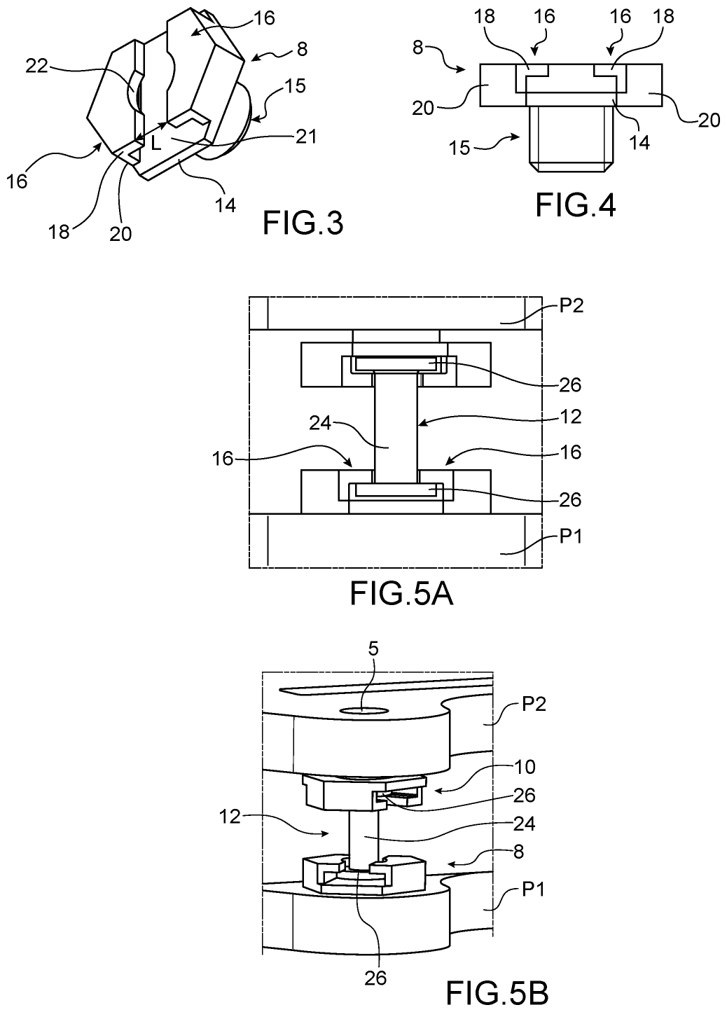

The first element, illustrated alone in FIG. 3, includes a plate 14 provided on a first face with a tapped pin 15 configured to be screwed into a threaded hole of the plate P1. The plate 14 includes, on a second face opposite to the first face, two jaws 16 delimiting therebetween a room for an end of the column and forming an axial stop for the latter. The axial direction is to be considered in the direction of the stack and extends orthogonally to the two stiffening plates P1, P2.

In FIG. 4, one could see, in side view, the first tapped element, each jaw includes a stop portion 18 extending parallel to and at a distance from the plate and a connection portion 20 connecting the stop portion 18 to the plate. The two stop portions 18 of the two jaws include lateral edges facing one another and forming therebetween a passage for the column. Advantageously, each of the lateral edges includes a recess 22, the two recesses delimiting a room for the column.

Preferably, the first element 8 has, in top view, a hexagonal shape enabling screwing thereof into a hole of the plate P1 by means of a standard flat key. Furthermore, the hexagonal shape is more practical for making the passage 21. Alternatively, the first element 8 has a polygonal shape including between 3 and n sides, for example 10. A polygonal shape has the advantage of enabling placing the clamping device in an environment having little space for placement of the tool; and furthermore, it allows easily arranging the passages parallel to each other for mounting the column, as will be explained hereinbelow.

The column 12 includes a rod 24 provided at each of its longitudinal ends with a head 26 in the form of a disk with an axis coincident with that of the rod, and with a diameter larger than that of the rod so as to connect to the rod 24 by a shoulder 28.

The width L of the passage 21 between the jaws is larger than the diameter of the rod and is smaller than the diameter of the head.

Quite advantageously, the distance between the connection portions of the two jaws is selected so as to be larger than the diameter of the head of the column.

Thus, the clearance provided between the head and the connection portions and between the rod and the room delimited by the recesses 22 in the stop portions advantageously allow compensating for flatness, orientation and coaxiality defects between the two stiffening plates. Thus, a slight offset of two threaded holes can be compensated by the lateral movements of the column in the first and second elements.

Mounting and operation of the clamping system S1 will now be described.

The first element 8 is screwed into a threaded hole of the plate P1, the second element 10 is screwed into the threaded hole facing the plate P2. The first and/or the second element(s) is or are not completely screwed into the threaded holes. In the illustrated example, the second element 10 is not completely screwed.

The first and second elements are oriented so that the passages 21 are parallel, enabling mounting of the heads of the column simultaneously in the first and second elements (FIG. 5A).

Afterwards, the column 12 is mounted in the first 8 and second 10 elements by making each head slide between the plate and the stop portions and the rod in the passage.

During a next step, the first and/or the second element(s) is or are screwed further, the heads then abut against the stop portions, the columns are then tensioned, which imparts a compressive force on the stack. In the illustrated example, it is the second element which is screwed further (FIG. 5B). The applied compressive force is in the range of 1 kN to a few kN.

The length of the rod 24 is selected according to the height of the stack and the number of interconnectors, so that it could exert, in cooperation with the first 8 and second 10 elements, a compressive force between the two stiffening plates.

All clamping devices S1 are mounted in the same manner between the two plates P1 and P2 and all around the stack ensuring application of a balanced compression force over the entire section of the stack. Preferably, between 4 and 12 clamping devices are mounted between the two plates, i.e. between a clamping device per side and three clamping devices per side.

The clamping devices are placed, for example, after the step of making the glass or glass-ceramic seals between the cells and the interconnectors. During this step, the compressive force is applied to the stack by means of a press. This step requires a high temperature. When this step is completed and the temperature has dropped and before the press stops exerting a compressive force, the clamping devices are placed so as to keep a compressive force applied by the press, after the latter has released its force. Afterwards, the press is controlled to release the compressive force. The module can then be handled while holding the compressive force.

Several modules are manufactured, then they are stacked so as to form an assembly (FIG. 1). An electrical contact element (not shown) may be arranged between two stiffening plates of two successive stacks. End plates PE1, PE2 are placed.

A seal should be made between the modules. For this purpose, the assembly is arranged in a press, which is actuated so as to apply a compressive force to the assembly. Afterwards, the clamping devices are removed. The sealing step takes place. Afterwards, the tie rods are placed between the end plates PE1, PE2.

Holding the compression throughout the entire manufacturing and then assembly of the stacks ensures protection of the seals and holding of the electrical contacts between the cells and the interconnectors.

On the one hand, the clamping devices allow holding application of a compressive force on the stacks between the phases under press. On the other hand, they allow superposing the stacks without any discomfort therebetween, unlike what would happen with these tie rods passing through the plates and bolts bearing on the external faces of the stiffening plates. Furthermore, the clamping devices S1 enable a relatively quick and simple mounting.

These mounting devices have the advantage of using identical or similar stiffening plates.

Preferably, the clamping devices are made of a high-strength steel in order to withstand the imposed stresses and deformation. Preferably, the material of the assembly devices has a Young's modulus higher than 10 GPa and a yield strength higher than ten times the maximum stress present in the tie rods of the final assembly when they are loaded.

For example, the clamping devices are made of X₄CrNiMo 16-05-01 stainless steel.

For example, the rods of the columns have a diameter comprised between 1 mm and 20 mm, preferably equal to 8 mm. Preferably, the number of columns and their diameter are selected so that the set of the columns is substantially more rigid than the stack. Advantageously, the ratio of the stiffness of the set of columns to the stiffness of the stack is comprised between 1 and 1000 and preferably in the range of 50.

In one embodiment, the clamping system includes several sets of columns of different lengths allowing adapting to stacks of different heights, the first and second tapped elements could be used for different column lengths.

The variation in height between two stacks may be partially compensated by the screwing level of the first and second elements in the threaded holes of the plates P1 and P2.

A clamping system for making a complete assembly including three modules comprises at least three sets of clamping devices, since each module is equipped with clamping devices, in particular when the three stacks are superposed.

In one embodiment, all or part of the columns 12 is/are equipped with a calibrated strain gauge allowing monitoring the forces applied during tensioning thereof. For example, the columns have a diametral bore in which the gauge is placed. Only one portion of the columns can be equipped with strain gauges, by coupling the measurement of the deformation to a measurement of the tightening torque on the first and second elements, it is possible to repeat clamping on the other clamping devices without using strain gauges.

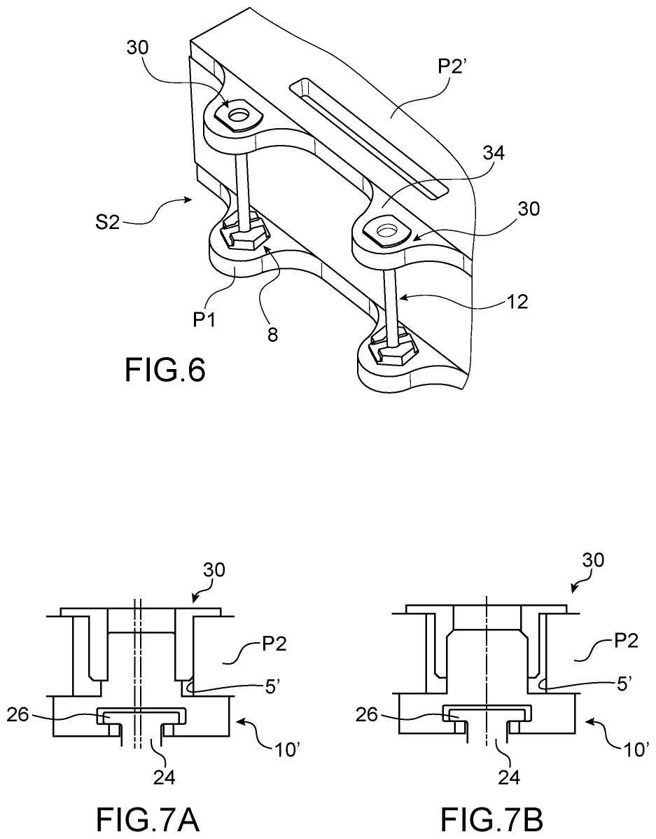

FIGS. 6, 7A and 7B show a variant of a stack of FIG. 1 having a substantially increased tolerance to the offset between the holes of the stiffening plates.

The clamping system S2 includes a first tapped element 8 identical or similar to the first element of the clamping system S1 and configured to be screwed directly into a threaded hole of the plate P1. The clamping system S2 also includes a second tapped element 10 identical or similar to the second element of the clamping system S1. The clamping system S2 also includes a nut 30 configured to be mounted with a transverse clearance in a hole 5′ of the stiffening plate P2. The second tapped element 10′ is configured to be screwed into the nut 30, it is similar to the second element 10. The nut 30 includes a base 32 intended to bear on the external face of the stiffening plate P2 so as to axially immobilise the nut 30 against the stiffening plate P2. Advantageously, the external face of the stiffening plate P2 is structured so that the nut 30 does not project from the external face and thus does not hinder the placement of another module. In the illustrated example, a counterbore 34 is formed in the lug, the counterbore having a depth at least equal to the thickness of the base 32 of the nut.

As one could see in FIGS. 7A and 7B, the nut 30 is free to move laterally in the hole 5′ of the stiffening plate P2′ in order to compensate for the misalignment between the holes 5′ of the two stiffening plates.

The positioning of the clamping devices is substantially identical to that of the devices of the clamping system S1. The first element is screwed into a hole of the stiffening plate P1, the nut 30 is placed in the hole 5 ‘of the stiffening plate P2, the second element 10’ is partially screwed into the nut 30. The column heads 12 are slid into the rooms of the first and second elements 8, 10′. Afterwards, the first element 8 and/or the second element 10′ is/are screwed further to tension the column 12. This placement is repeated for all clamping devices.

In this variant, either the holes in the plate P2′ have a larger diameter than the diameter of the holes of the plate P1, or the threaded portion of the second element has a smaller diameter than that of the first element.

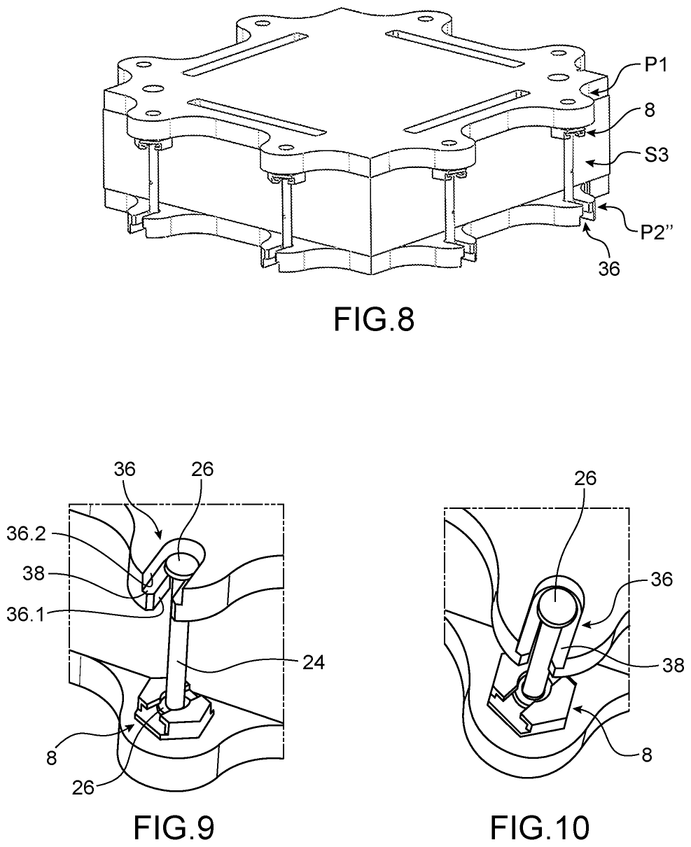

In FIGS. 8 to 10, one could see another embodiment of a stack according to the invention.

The clamping system S3 includes a first tapped element and a column. One of the heads of the column cooperates with the first tapped element and the other head cooperates directly with the stiffening plate P2″.

The stiffening plate P2″ includes rooms 36 for each head formed by a hole crossing the plate and opening laterally outwards of the edge of the stiffening plate P2′″. Each room 36 is open-through and includes a first portion 36.1 with a first width and a second portion 36.2 with a second width larger than the first width, defining therebetween a shoulder 38 forming an axial stop for the head of the column.

Advantageously, the depth of the second portion 36.2 is sufficient for the head not to project from the stiffening plate P2″.

Placement of the clamping devices will now be described.

The first element 8 is partially screwed into the hole and is oriented so as to enable mounting of the column heads in the room of the first element and the room of the stiffening plate P2″, the head received in the room 36 bears on the shoulder 38. Afterwards, the first element 8 is screwed further into the hole of the stiffening plate P1 so as to tension the column. This operation is repeated for each of the clamping devices.

This embodiment has the advantage of simplifying mounting and making it quicker since it requires only screwing of a tapped element. Furthermore, the module has a reduced height.

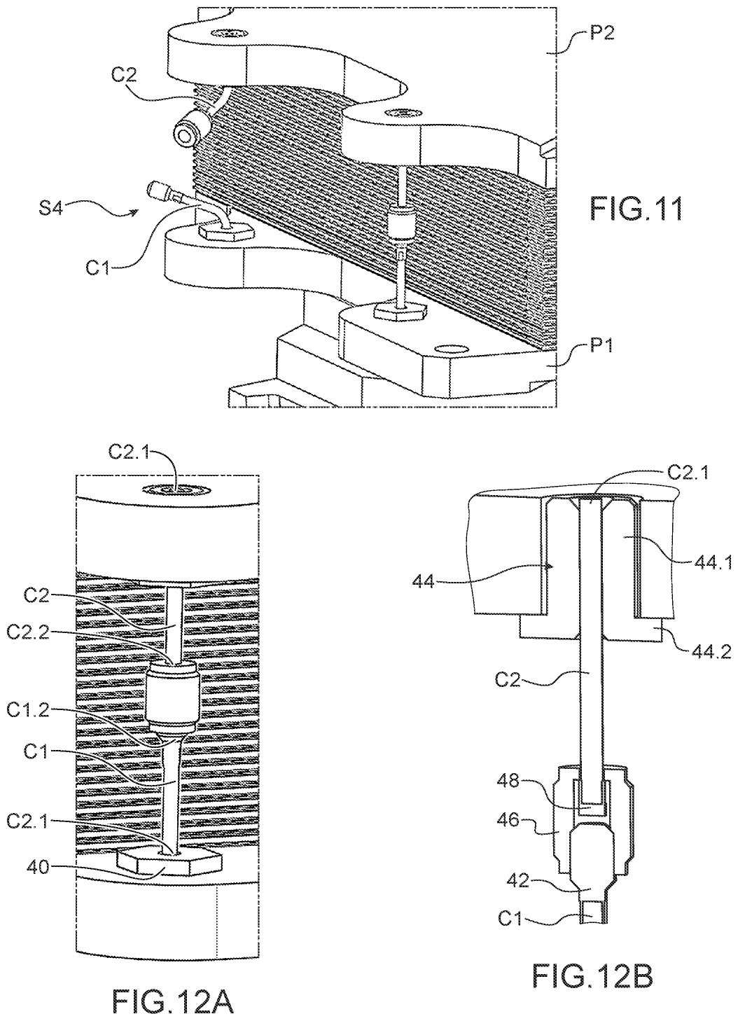

In FIGS. 11, 12A and 12B, one could see another embodiment of the clamping devices.

The clamping system S4 includes clamping devices including a first cable C1 fastened to the stiffening plate P1 and a second cable C2 fastened to the stiffening plate P2 and a device for connecting the cables and for tensioning them. Preferably, the cables C1 and C2 have the same diameter. Once assembled, the two cables C1, C2 ensure the column function.

The first cable C1 is provided at one end C1.1 with a tapped element 40 configured to be screwed into a hole of the stiffening plate P1. The end C1.1 is welded to the tapped element 40. The first cable C1 is provided at its other end C1.2 with a threaded endpiece 42, for example crimped onto the end C1.2 of the cable.

The second cable C2 is provided at one end C2.1 with a tapped element 44 configured to be screwed into a hole in the stiffening plate P2. The end C2.1 is welded to the tapped element 44.

The second cable C2 is provided at its other end C2.2 with a nut 46, mounted mobile in rotation around the cable C2 and in translation along the cable C2 so as to be able to be screwed onto the endpiece 42 carried by the cable C1. For example, the cable C2 is inserted into the nut 46 and a ring 48 is crimped onto the end C2.2 of the cable C2 to limit the translation of the nut on the cable C2. Alternatively, the nut 46 is fixed in rotation on the cable C2 and the cable C2 is mounted free to rotate in the tapped element 44.

Each tapped element 40, 44 includes a tapped portion 44.1 for cooperating with a hole of a stiffening plate P1, P2 and a clamping portion 44.2 enabling clamping of the elements 40, 44 in the holes, the clamping portions advantageously have a polygonal shape, preferably hexagonal.

Alternatively, the cables are mounted on the plates like in the example of FIG. 8.

Placement of the clamping devices will now be described.

The tapped element 40 is screwed into a hole 8 of the stiffening plate P1, the tapped element 44 is screwed into a hole 10 of the stiffening plate P2. The nut 46 is screwed onto the endpiece 42 until tensioning the cables C1 and C2.

The cables C1 and C2 are selected so as to have enough stiffness. Similarly to the rigid column clamping systems, preferably, the number of cable clamping devices and the diameter of the cables are selected so that all clamping devices are substantially more rigid than the stack. Advantageously, the ratio of the stiffness of the set of clamping devices to the stiffness of the stack is comprised between 1 and 1,000 and preferably in the range of 50.

The clamping system according to the invention allows holding stacks in compression while avoiding having elements projecting from the external faces of the stiffening plates which simplifies the superposition of the stacks.

1. A clamping system for a module comprising a stack of electrochemical cells and interconnectors in a longitudinal direction, and a first stiffening plate and a second stiffening plate on either side of the stack,
wherein the clamping system is configured to exert a compressive force on the stack in the longitudinal direction,
wherein each first and second stiffening plates includes n holes orthogonal to the stiffening plates and distributed along edges of the stiffening plates, n being an integer at least equal to 2,
wherein the clamping system includes n clamping devices, each clamping device including a column configured to mechanically connect the first and the second stiffening plates, each column extending into a space between the first and second stiffening plates, and
wherein each clamping device also includes a first means penetrating each of the first and second stiffening plates and fastening the column to the first and second stiffening plates and a second adjustment means for adjusting a tension applied to the column.

2. The clamping system according to claim 1, wherein the first means include, at each of the stiffening plates, a room for a column head, configured to enable mounting of a column head in the room by lateral movement of the column.

3. The clamping system according to claim 1, wherein the first means include at least one first tapped element configured to be screwed into a hole of one of the stiffening plates.

4. The clamping system according to claim 3, wherein the column includes, at a first longitudinal end, a head cooperating with the first tapped element and, at a second longitudinal end, a head configured to connect to the second stiffening plate, and
wherein the second adjustment means are formed by cooperation of the first tapped element with the first stiffening plate.

5. The clamping system according to claim 3, wherein the first tapped element includes a room for a column head, configured to enable mounting of a column head in the room by lateral movement of the column.

6. The clamping system according to claim 5, wherein the first means include a second tapped element configured to be screwed into a hole of the second stiffening plate, and wherein the second tapped element includes a room for a column head, configured to enable mounting of a column head in the room by lateral movement of the column.

7. The clamping system of claim 6, wherein the rooms and the heads are configured to form a lateral clearance therebetween.

8. The clamping system according to claim 5, wherein the clamping device includes at least one nut configured to be mounted with a lateral clearance in a hole of the second stiffening plate and to be immobilised in translation in the axial direction at least in a direction opposite to that in which the second tapped element is screwed into the hole.

9. The clamping system of claim 1, wherein each column includes two cables, each configured to be fastened by a first end at least in translation in the axial direction to the first and second stiffening plates and including, at a second end, means for connecting the cables together, forming the second adjustment means.

10. The clamping system according to claim 9, wherein the first means include a second tapped element configured to be screwed into a hole of the second stiffening plate, the first end of a cable being welded in the first tapped element and the first end of the other cable is welded in the second tapped element.

11. The clamping system according to claim 10, wherein the second adjustment means include a nut mounted free to rotate on the second end of one of the cables and a tapped pin mounted on the second end of the other cable.

12. The clamping system according to claim 1, wherein at least one clamping device includes a strain gauge configured to provide the tension applied to the column.

13. A module, comprising:
a stack of electrochemical cells and interconnectors;
a first and second stiffening plate on either side of the stack; and
a clamping system according to claim 1,
wherein the first and second stiffening plates include holes for mounting the clamping devices arranged along the edges of the stiffening plates.

14. The module according to claim 13,
wherein the first means include at least one first tapped element configured to be screwed into a hole of one of the stiffening plates,
wherein the column includes, at a first longitudinal end, a head cooperating with the first tapped element and, at a second longitudinal end, a head configured to connect to the second stiffening plate,
wherein the second adjustment means are formed by cooperation of the first tapped element with the first stiffening plate, and
wherein the holes of the second stiffening plate open laterally into the edges of the second stiffening plate, the holes including a shoulder forming a bearing face for a column head.

15. The module according to claim 13,
wherein the first means include at least one first tapped element configured to be screwed into a hole of one of the stiffening plates,
wherein the first tapped element includes a room for a column head, configured to enable mounting of a column head in the room by lateral movement of the column,
wherein the clamping device includes at least one nut configured to be mounted with a lateral clearance in a hole of the second stiffening plate and to be immobilised in translation in the axial direction at least in a direction opposite to that in which the second tapped element is screwed into the hole,
wherein the nut includes a collar bearing against an area of an external face of the second stiffening plate, and wherein the area includes a counterbore so that the collar does not project from a main plane of the external face.

16. A method for compressing a stack of electrochemical cells and interconnectors of with a clamping system according to claim 1, the method comprising:
a) providing a stack of electrochemical cells and interconnectors and first and second stiffening plates on either side of the stack, each of the plates including n holes orthogonal to the stiffening plates and distributed along the edges of the stiffening plates;
b) mounting a first tapped element in a hole of the first stiffening plate for each clamping device;
c) mounting the column between the first element and the second stiffening plate; and
d) tensioning the column.

17. The compression method according to claim 16, wherein during step d), tensioning is achieved by screwing the first tapped element into the hole.

18. The compression method according to claim 16, wherein in step c), a second tapped element is mounted in a hole of the second stiffening plate, and
wherein in step d), the tensioning is achieved by screwing the first element into the hole and/or screwing the second element into the hole.

19. A method for compressing a stack of electrochemical cells and interconnectors with a clamping system according to claim 9, the method comprising:
a) providing a stack of electrochemical cells and interconnectors and first and second stiffening plates on either side of the stack, each of the first and second stiffening plates including n boles orthogonal to the stiffening plates and distributed along the edges of the first and second stiffening plates;
b) mounting a first tapped element in a hole of the first stiffening plate for each mounting device;
c) mounting a second tapped element in a hole of the second stiffening plate for each mounting device; and
d) connecting the cables and tensioning the cables.

20. A method for manufacturing an electrochemical assembly forming an electrolysis or co-electrolysis reactor SOEC or a fuel cell SOFC, including a superposition of p modules, p being an integer at least equal to 2, the method comprising:
a′) providing a stack of electrochemical cells and interconnectors and first and second stiffening plates on either side of the stack, each of the first and second stiffening plates including n holes orthogonal to the stiffening plates and distributed along the edges of the first and second stiffening plates;
b′) placing the stack and first and second stiffening plates in a press;
c′) applying a given axial compressive force;
d′) making a seal between the cells and the interconnectors;
e′) placing the clamping system by applying the method according to claim 16;
f′) repeating steps a′) to e′) to manufacture p modules;
g′) superposing the modules;
h′) placing the superposed modules in a press;
i′) applying an axial compressive force to the superposed modules;
j′) removing clamping systems from all of the modules;
k′) making a seal between the modules;
l′) mounting a system for holding the modules in compression; and
m′) removing the press.
